(19) United States
(12) Patent Application Publication
(10) Pub. No.: US 2017/0284886 A1
(43) Pub. Date: Oct. 5, 2017

(54) WATERPROOF PRESSURE SENSOR AND METHOD FOR MANUFACTURING WATERPROOF PRESSURE SENSOR

(71) Applicant: Alps Electric Co., Ltd., Tokyo (JP)

(72) Inventors: Hisanobu OKAWA, Miyagi-ken (JP); Eiji UMETSU, Miyagi-ken (JP); Hideki KAMIMURA, Miyagi-ken (JP)

(21) Appl. No.: 15/399,634

(22) Filed: Jan. 5, 2017

(30) Foreign Application Priority Data
Mar. 30, 2016 (JP) 2016-068863

(51) Int. Cl. G01L 19/06; B29C 45/00; G01L 9/00

(52) U.S. Cl. CPC G01L 19/0645; G01L 9/0042; B29C 45/0082

(57) ABSTRACT

A waterproof pressure sensor includes a pressure detection element, a cavity package configured to be provided with a recess in which the pressure detection element is mounted and an edge provided around the recess, a cover member attached to the edge of the cavity package and to be provided with a pressure introducing hole having a diameter smaller than a diameter of an opening of the recess in a plan view at a position overlapping the recess, and a gel agent configured to be provided in the recess, in which an exhaust portion is provided at the cover member at least on the recess side, the exhaust portion being capable of discharging air in the recess to the outside when the gel agent is injected from the pressure introducing hole into the recess, and the exhaust portion is filled with the gel agent.

### CLAIM OF PRIORITY

This application claims benefit of Japanese Patent Application No. 2016-068863 filed on Mar. 30, 2016, which is hereby incorporated by reference.

### BACKGROUND OF THE INVENTION

### 1. Field of the Invention

The present invention relates to a waterproof pressure sensor and a manufacturing method for the waterproof pressure sensor, and particularly to a waterproof pressure sensor in which a pressure detection element is covered with a gel agent and a manufacturing method for the waterproof pressure sensor.

### 2. Description of the Related Art

In order to cause a pressure sensor to have a waterproof function, a pressure detection element is required to be covered with a soft resin such as gel. The resin climbs up a wall surface during curing, and there is a problem in that the resin protrudes to the outside and entrapment of air bubbles occurs at the time of coating.

Japanese Unexamined Patent Application Publication No. 2006-220456 discloses a relative pressure type pressure sensor in which a back side of a sensor chip is sealed with a gel member. In the pressure sensor, a pressure introducing hole is provided with a chip back side gel member for sealing the back side of the sensor chip. The chip back side gel member has a two-layer structure in which a hard gel covers a soft gel.

However, in the pressure sensor disclosed in Japanese Unexamined Patent Application Publication No. 2006-220456, when the gel with the two-layer structure is formed, two kinds of liquid agents are repeatedly coated before curing, and thus it is hard to form a stable upper gel. The two kinds of liquid agents are used, and this increases the number of manufacturing steps or cost. The hard gel is less likely to climb up a wall surface than the soft gel, but climbs up when the liquid agent is cured, and thus is not suitable for miniaturization, especially, reduction in height. A liquid agent is likely to contain air bubbles when the liquid agent is injected so as to be gelled, and, if the air bubbles remain in a gel agent, this reduces the pressure detection accuracy due to the influence of expansion and contraction of air in the air bubbles.

### SUMMARY OF THE INVENTION

The present invention provides a waterproof pressure sensor capable of simplifying manufacturing steps and having a structure in which air bubbles hardly remain in a gel agent, and a manufacturing method for the waterproof pressure sensor.

According to an aspect of the present invention, there is provided a waterproof pressure sensor including a pressure detection element; a cavity package configured to be provided with a recess in which the pressure detection element is mounted and an edge provided around the recess; a cover member attached to the edge of the cavity package and to be provided with a pressure introducing hole having a diameter smaller than a diameter of an opening of the recess in a plan view at a position overlapping the recess; and a gel agent configured to be provided in the recess, in which an exhaust portion is provided at the cover member at least on the recess side, the exhaust portion being capable of discharging air in the recess to the outside when the gel agent is injected from the pressure introducing hole into the recess, and the exhaust portion is filled with the gel agent.

According to the configuration, even if air is entrapped by a liquid agent when the liquid agent serving as the gel agent is injected from the pressure introducing hole into the recess, the air is discharged to the outside through the exhaust portion. Therefore, it is possible to prevent air bubbles from remaining in the gel agent.

In the waterproof pressure sensor according to the aspect of the present invention, the exhaust portion may be provided to communicate with the pressure introducing hole. Consequently, air entrapped by the liquid agent proceeds to the pressure introducing hole along the exhaust portion, and is discharged to the outside through the pressure introducing hole.

In the waterproof pressure sensor according to the aspect of the present invention, the exhaust portion may include a diameter increasing portion whose diameter increases from the outside of the cover member toward the recess side. Consequently, air entrapped by the liquid agent when injecting a liquid agent serving as the gel agent is gradually pushed toward the pressure introducing hole along the diameter increasing portion and is then discharged to the outside.

In the waterproof pressure sensor according to the aspect of the present invention, a shape of the diameter increasing portion in a plan view may be a polygonal shape or a circular shape. Consequently, when a liquid agent serving as the gel agent is injected from the pressure introducing hole, the liquid agent radially spreads from an injection position in the recess, and thus entrapment of air can be prevented.

In the waterproof pressure sensor according to the aspect of the present invention, an outer shape of the diameter increasing portion in a plan view may be located outside a vertex of a loop of a bonding wire connected to a component mounted in the recess. Consequently, it is possible to prevent interference between the loop of the bonding wire and the cover member and thus to realize a reduction in height.

In the waterproof pressure sensor according to the aspect of the present invention, an extension direction of the bonding wire in a plan view may be a direction which is not orthogonal to a radial direction from the center of the pressure introducing hole. Consequently, when a liquid agent serving as the gel agent is injected from the pressure introducing hole, the liquid agent easily flows along the bonding wire, and thus it is possible to prevent entrapment of air.

The waterproof pressure sensor according to the aspect of the present invention may further include a circuit element configured to be connected to the pressure detection element, and the pressure detection element may overlap the circuit element. Consequently, it is possible to miniaturize the waterproof pressure sensor.

According to another aspect of the present invention, there is provided a manufacturing method for the waterproof pressure sensor, the method including a step of mounting the pressure detection element in the recess of the cavity package; a step of attaching the cover member to the edge of the cavity package so that the recess overlaps the pressure introducing hole; and a step of injecting a liquid agent into the recess from the pressure introducing hole so as to gel the liquid agent, in which, when the liquid agent is injected, the liquid agent fills the recess and then fills the exhaust portion so that air bubbles in the liquid agent is discharged to the outside of the cover member.

According to the configuration, even if air is entrapped by a liquid agent when the liquid agent serving as the gel agent is injected from the pressure introducing hole into the recess, the air is discharged to the outside through the exhaust portion. Therefore, it is possible to prevent air bubbles from remaining in the gel agent.

In the manufacturing method for the waterproof pressure sensor according to the aspect of the present invention, when the liquid agent is injected from the pressure introducing hole, the liquid agent may be injected from the center of the recess to the outside of the center in a plan view. Consequently, when a liquid agent serving as the gel agent is injected from the pressure introducing hole, the liquid agent radially spreads from an injection position in the recess, and thus entrapment of air can be prevented.

According to the present invention, it is possible to provide a waterproof pressure sensor capable of simplifying manufacturing steps and having a structure in which air bubbles hardly remain in a gel agent, and a manufacturing method for the waterproof pressure sensor.

### BRIEF DESCRIPTION OF THE DRAWINGS

FIG. 1 is a sectional view exemplifying a waterproof pressure sensor according to a first embodiment.

FIGS. 2A and 2B are plan views exemplifying the waterproof pressure sensor according to the first embodiment.

FIGS. 3A and 3B are sectional views exemplifying a state of a gel agent.

FIGS. 4A to 4C are sectional views exemplifying a manufacturing method for the waterproof pressure sensor according to the present embodiment.

FIGS. 5A to 5C are sectional views exemplifying a manufacturing method for the waterproof pressure sensor according to the present embodiment.

FIG. 6 is a sectional view exemplifying a waterproof pressure sensor according to a second embodiment.

FIG. 7 is a sectional view exemplifying a waterproof pressure sensor according to a third embodiment.

### DESCRIPTION OF THE PREFERRED EMBODIMENTS

Hereinafter, embodiments of the present invention will be described with reference to the drawings. In the following description, the same members are given the same reference numerals, and members described once will not be described as appropriate.

### First Embodiment

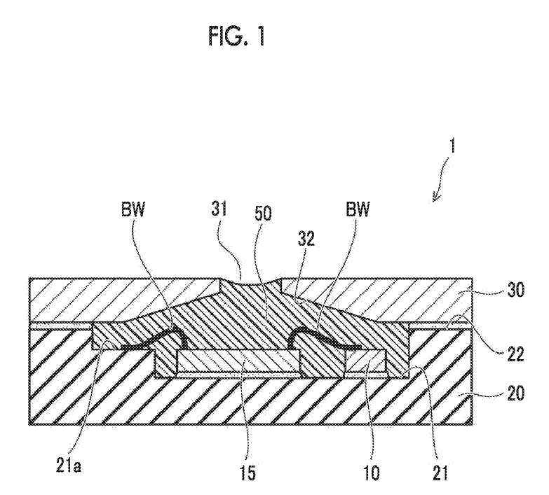

FIG. 1 is a sectional view exemplifying a waterproof pressure sensor according to a first embodiment.

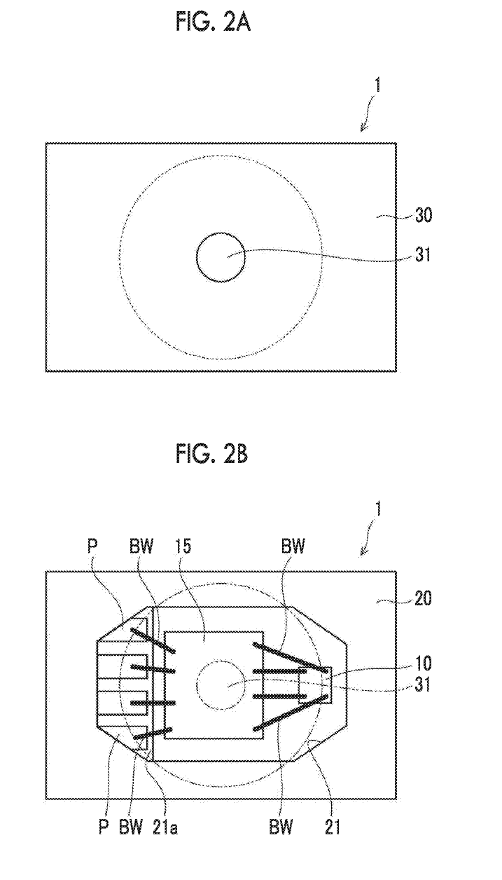

FIGS. 2A and 2B are plan views exemplifying the waterproof pressure sensor according to the first embodiment. FIG. 2A is a plan view illustrating a state in which a cover member 30 is provided, and FIG. 2B is a plan view in a state in which the cover member 30 is not provided.

A waterproof pressure sensor 1 according to the present embodiment is a sensor detecting applied sensor with a pressure detection element 10, and has a waterproof function by covering a periphery of the pressure detection element 10 with a gel agent 50.

The waterproof pressure sensor 1 includes the pressure detection element 10, a cavity package 20, the cover member 30, and the gel agent 50. The pressure detection element 10 is, for example, a chip component in which a diaphragm is formed in a semiconductor such as silicon through etching.

The cavity package 20 includes a recess 21 on which the pressure detection element 10 is mounted, and an edge 22 provided around the recess 21. The cavity package 20 is made of, for example, ceramics such as alumina. Metallized patterns P are formed on a step difference portion 21a or the like of the recess 21. In the present embodiment, in addition to the pressure detection element 10, a circuit element 15 is also mounted in the recess 21. Bonding wires BW are connected to the pressure detection element 10 and the circuit element 15, and thus the elements are connected to each other or connected to the metallized patterns P.

The cover member 30 is attached onto the edge 22 of the cavity package 20 via an adhesive. A ceramic is used for the cover member 30 in the same manner as for the cavity package 20. A pressure introducing hole 31 is provided at the substantially center of the cover member 30. A diameter of the pressure introducing hole 31 is smaller than a diameter of an opening of the recess 21 in a plan view. The pressure introducing hole 31 is disposed at a position overlapping the recess 21 in a state in which the cover member 30 is attached onto the cavity package 20.

The gel agent 50 is provided in the recess 21. In other words, the gel agent 50 fills the recess 21 so as to cover the pressure detection element 10 and the circuit element 15 mounted in the recess 21 and the bonding wires BW. For example, a fluorine gel or silicone gel is used for the gel agent 50.

In the waterproof pressure sensor 1 having the configuration, a tapered portion 32 as an exhaust portion is provided on at least the recess 21 side of the cover member 30. The tapered portion 32 is a diameter increasing portion whose diameter increases from the outside of the cover member 30 toward the recess 21 side. The gel agent 50 fills the recess 21 and also fills the tapered portion 32.

The tapered portion 32 is provided to communicate with the pressure introducing hole 31. Since the tapered portion 32 is provided at the cover member 30, even if air is entrapped by a liquid agent when the liquid agent serving as the gel agent 50 is injected from the pressure introducing hole 31 into the recess 21, air bubbles caused by the air are discharged to the outside from the tapered portion 32 via the pressure introducing hole 31. Therefore, it is possible to prevent air bubbles from remaining in the gel agent 50.

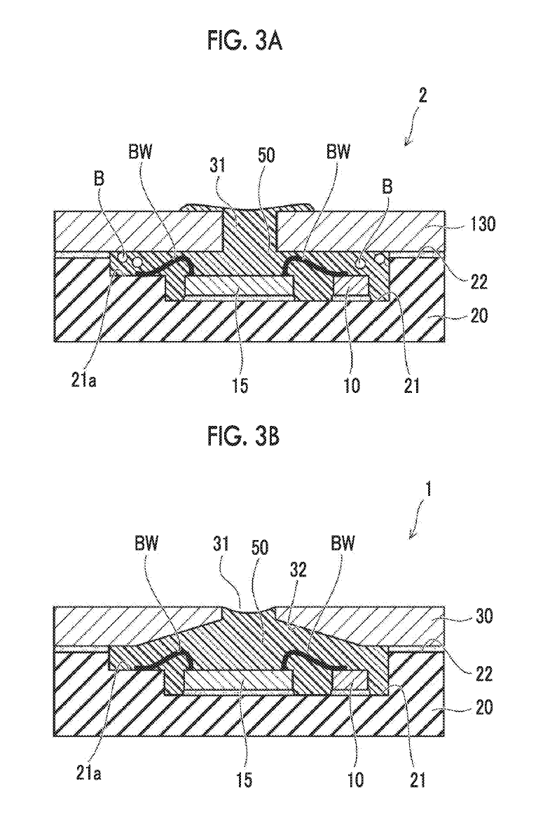

FIGS. 3A and 3B are sectional views exemplifying states of the gel agent.

FIG. 3A exemplifies a waterproof pressure sensor 2 according to a reference example, and FIG. 3B exemplifies the waterproof pressure sensor 1 according to the present embodiment.

In the waterproof pressure sensor 2 according to the reference example illustrated in FIG. 3A, an exhaust portion is not provided at a lid 130. Thus, in the waterproof pressure sensor 2, when a liquid agent serving as the gel agent 50 is injected from the pressure introducing hole 31 into the recess 21, entrapped air is likely to cause air bubbles B which tends to remain between a rear surface of the lid 130 and the recess 21.

On the other hand, in the waterproof pressure sensor 1 according to the present embodiment, even if air is entrapped when a liquid agent serving as the gel agent 50 is injected from the pressure introducing hole 31 into the recess 21, air bubbles can be pushed up along the tapered portion 32 as a result of the liquid agent being injected, and thus the air bubbles escape to the outside through the pressure introducing hole 31. Therefore, it is possible to prevent air bubbles from remaining the gel agent 50.

### Method Manufacturing for Waterproof Pressure Sensor

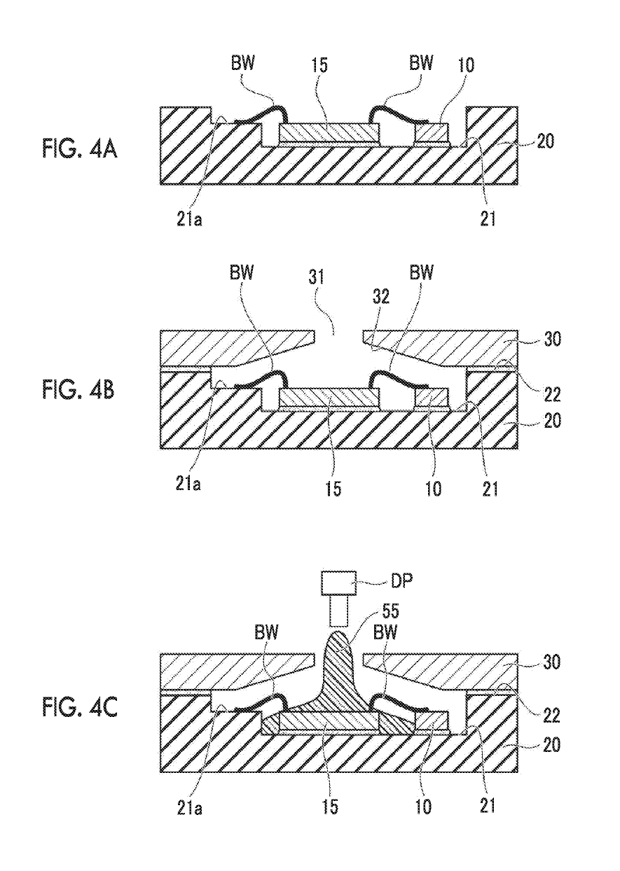

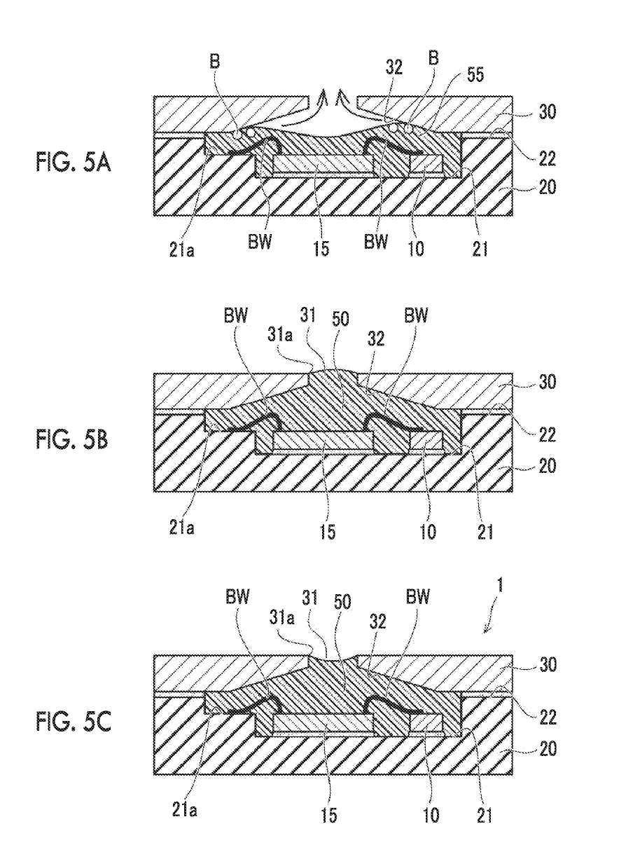

FIGS. 4A to 5C are sectional views exemplifying a manufacturing method for the waterproof pressure sensor according to the present embodiment. First, as illustrated in FIG. 4A, the cavity package 20 with the recess 21 is prepared, and the pressure detection element 10 and the circuit element 15 are mounted in the recess 21. The pressure detection element 10 and the circuit element 15 are fixed to a mounting surface of the recess 21 via, for example, a die bond resin.

Next, the bonding wires BW are wired. The bonding wires BW are wired between the circuit element 15 and the metallized patterns P (refer to FIG. 2B) or between the circuit element 15 and the pressure detection element 10.

Next, as illustrated in FIG. 4B, the cover member 30 is attached onto the edge 22 of the cavity package 20. The cover member 30 is connected to the edge 22 via an adhesive. Next, as illustrated in FIG. 4C, a liquid agent 55 serving as the gel agent 50 is injected from the pressure introducing hole 31 of the cover member 30. The liquid agent 55 is injected into the recess 21 from the pressure introducing hole 31 by using, for example, a dispenser DP. At this time, the liquid agent 55 is preferably injected into the recess 21 from the center of the pressure introducing hole 31. Consequently, the liquid agent 55 radially spreads from the injection position in the recess 21, and thus entrapment of air can be prevented.

If extension directions of the bonding wires BW in a plan view are set to directions which are not orthogonal to a radial direction from the center of the recess 21 when the bonding wires BW are wired, the liquid agent 55 easily flows along the bonding wires BW when the liquid agent 55 is injected. Consequently, it is possible to prevent air from being entrapped by the liquid agent 55.

FIG. 5A illustrates a state in which the recess 21 is filled with the liquid agent 55. If the recess 21 is filled with the liquid agent 55, a liquid surface gradually increases. If air is entrapped when the liquid agent 55 is injected, air bubbles B are generated. The air bubbles B are pushed up along with injection of the liquid agent 55, and rise along the tapered portion 32. The air bubbles B are discharged to the outside through the pressure introducing hole 31.

As illustrated in FIG. 5B, the liquid agent 55 fills the recess 21 and the tapered portion 32, and also fills a position of an upper edge 31a of the pressure introducing hole 31. Next, as illustrated in FIG. 5C, the gel agent 50 is formed by curing the liquid agent 55. If the liquid agent 55 is gelled, a position of a surface of the gel agent 50 is slightly lower than a position of the upper edge 31a of the pressure introducing hole 31. Consequently, the waterproof pressure sensor 1 is completed.

According to the manufacturing method, even if air is entrapped by the liquid agent 55 and thus the air bubbles B are generated when the liquid agent 55 is injected from the pressure introducing hole 31 into the recess 21, the air bubbles B can be discharged to the outside along the tapered portion 32. Therefore, it is possible to prevent air bubbles from remaining in the gel agent 50.

### Second Embodiment

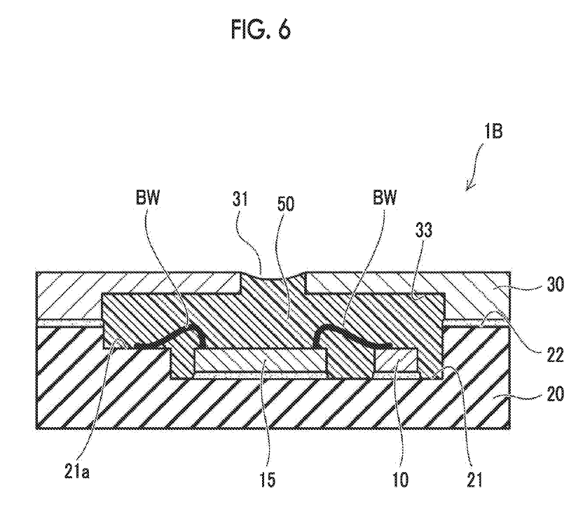

FIG. 6 is a sectional view exemplifying a waterproof pressure sensor according to a second embodiment.

In a waterproof pressure sensor 1B according to the present embodiment, a counterbore portion 33 which is approximately at right angles is provided as an exhaust portion at the cover member 30 on the recess 21 side. Since the counterbore portion 33 is provided, when the liquid agent 55 is injected from the pressure introducing hole 31 into the recess 21, it takes time for the surface of the liquid agent 55 to reach the rear surface of the cover member 30. Therefore, there is a high probability that the air bubbles B generated in the liquid agent 55 may float upward as a result of injection of the liquid agent 55. Consequently, the air bubbles B are easily discharged to the outside through the pressure introducing hole 31.

### Third Embodiment

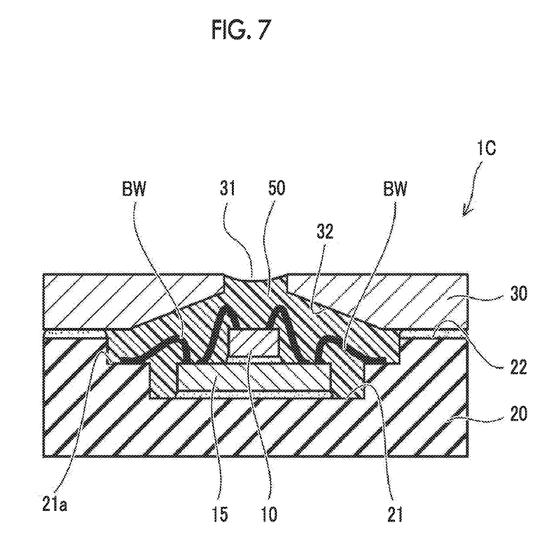

FIG. 7 is a sectional view exemplifying a waterproof pressure sensor according to a third embodiment.

In a waterproof pressure sensor 1C according to the present embodiment, the pressure detection element 10 overlaps the circuit element 15 in the recess 21 of the cavity package 20. If the pressure detection element 10 overlaps the circuit element 15, it is possible to miniaturize the waterproof pressure sensor 1C in a plan view. In the present embodiment, the pressure detection element 10 is disposed inside the tapered portion 32 of the cover member 30, and thus it is possible to realize a reduction in height even if the pressure detection element 10 overlaps the circuit element 15.

As described above, according to the embodiments, it is possible to provide the waterproof pressure sensors 1, 1B and 1C in which manufacturing steps are simplified and air bubbles B do not remain in the gel agent 50, and the manufacturing method for the waterproof pressure sensor.

The present embodiments have been described above, but the present invention is not limited to such embodiments. For example, the tapered portion 32 and the counterbore portion 33 have been described as examples of exhaust portions, but a hole which penetrates to the recess 21 may be provided in the cover member 30 as an exhaust portion, and the air bubbles B generated when the liquid agent 55 is injected may be discharged to the outside through the hole. Embodiments obtained by a person skilled in the art adding or deleting constituent elements to or from the above-described embodiments, or modifying design of the above-described embodiments, or embodiments obtained by combining the features of the configuration examples of the respective embodiments with each other as appropriate are all included in the scope of the present invention without departing from the spirit of the present invention.

It should be understood by those skilled in the art that various modifications, combinations, sub-combinations and alterations may occur depending on design requirements and other factors insofar as they are within the scope of the appended claims of the equivalents thereof.

1. A waterproof pressure sensor comprising:
a pressure detection element;
a cavity package including a recess and an edge portion surrounding the recess, the pressure detection element being mounted in the recess;
a cover member attached to the edge portion of the cavity package to cover the cavity package, the cover member having a pressure introducing hole disposed above the recess, the pressure introducing hole having a diameter smaller than a diameter of an opening of the recess; and
a gel agent provided in the recess,
wherein the cover member includes an exhaust structure facing the recess, the exhaust structure being configured to discharge air in the recess to outside of the recess by guiding the air along the exhaust structure to the pressure introducing hole while the gel agent is being injected from the pressure introducing hole into the recess and a space under the exhaust structure.

2. The waterproof pressure sensor according to claim 1,
wherein the exhaust structure communicates with the pressure introducing hole.

3. The waterproof pressure sensor according to claim 1,
wherein the exhaust structure includes a diameter increasing portion whose diameter increases from an upper side of the cover member toward the recess side.

4. The waterproof pressure sensor according to claim 3,
wherein an outer periphery of the diameter increasing portion in a plan view has a polygonal shape or a circular shape.

5. The waterproof pressure sensor according to claim 3, further comprising a component mounted in the recess, the component having a bonding wire connected thereto,
wherein a vertex of a loop of the bonding wire is disposed inside an outer periphery of the diameter increasing portion in a plan view.

6. The waterproof pressure sensor according to claim 5,
wherein the bonding wire in a plan view extends in a direction which is not orthogonal to a radial direction from the center of the pressure introducing hole.

7. The waterproof pressure sensor according to claim 1, further comprising:
a circuit element connected to the pressure detection element, wherein the pressure detection element is mounted on the circuit element.

8. A method for manufacturing the waterproof pressure sensor according to claim 1, the method comprising:
mounting the pressure detection element in the recess of the cavity package;
attaching the cover member to the edge portion of the cavity package such that the pressure introducing hole is disposed above the recess; and
injecting a liquid agent into the recess from the pressure introducing hole so as to gel the liquid agent into the gel agent,
wherein, when the liquid agent is injected, the liquid agent fills the recess and then fills a space under the exhaust structure such that air bubbles in the liquid agent are guided along the exhaust structure and discharged to outside of the cover member through the pressure introducing hole.

9. The method according to claim 8,
wherein in the injecting the liquid agent into the recess, the liquid agent is injected from a center of the recess toward a periphery thereof in a plan view.

10. The waterproof pressure sensor according to claim 1, wherein the exhaust structure is configured to guide the air upward to the pressure introducing hole.

11. The waterproof pressure sensor according to claim 1, wherein the exhaust structure includes a tapered surface forming a mouth opening to the recess.

12. A method for manufacturing a waterproof pressure sensor, the method comprising:
providing a cavity package including a recess and an edge portion surrounding the recess;
mounting a pressure detection element in the recess;
providing a cover member having a pressure introducing hole and an exhaust structure communicating with the pressure introducing hole;
attaching the cover member to the edge portion of the cavity package such that the exhaust structure faces the recess and the pressure introducing hole is disposed above the recess at a center thereof, the pressure introducing hole having a diameter smaller than a diameter of an opening of the recess;
injecting a liquid agent into the recess from the pressure introducing hole such that the liquid agent fills the recess and a space under the exhaust structure; and
gelling the liquid agent into a gel agent,
wherein in injecting the liquid agent into the recess, air bubbles in the liquid agent are guided upward along the exhaust structure and discharged to outside of the cover member through the pressure introducing hole.

13. The method according to claim 11, wherein the exhaust structure includes a tapered surface forming a mouth opening to the recess.
